(19) United States
(12) Patent Application Publication
(10) Pub. No.: US 2014/0015806 A1
(43) Pub. Date: Jan. 16, 2014

(54) INPUT PANEL CONSISTING OF A DISPLAY PANEL AND A PHOTO-SENSITIVE DETECTOR PANEL, FOR A DATA PROCESSING INSTALLATION

(71) Applicant: Robert Koeppe, Linz (AT)

(72) Inventor: Robert Koeppe, Linz (AT)

(73) Assignee: ISIQIRI INTERFACE TECHNOLOGIES GMBH, Hagenberg (AT)

(21) Appl. No.: 14/007,509

(22) PCT Filed: Mar. 26, 2012
(86) PCT No.: PCT/AT12/00079

§ 371 Date: Sep. 30, 2013

(30) Foreign Application Priority Data
Mar. 31, 2011 (AT) A 454/2011

(51) Int. Cl. G06F 3/042

(52) U.S. Cl. CPC G06F 3/0421
USPC 345/175

(57) ABSTRACT

An input panel having a display panel and a photosensitive detector panel, for controlling a data processing installation. Also disclosed is a method for operating such an input panel. In one preferred embodiment, the detector panel and the display panel are arranged at a distance from one another and the layer which adjoins the detector panel on the display panel side is an air layer. In a preferred mode of operation, a beam of light which is emitted by a light pointer device onto the input panel for the purpose of controlling the data processing installation has radiation components in two different spectral ranges, one radiation component being in the spectral range of visible light and the second radiation component being in the spectral range of IR light or UV light, with only the radiation component which is present as IR or UV light being absorbed by the detector panel.

The invention relates to an input panel consisting of a display panel and a photosensitive detector panel, for a data processing installation.

The designation “input panel for a data processing installation” is used here in the meaning of a panel, on which the position coordinates of a local input marking displaceable by a human are recognizable by a data processing installation, wherein different panel regions on the input panel can be assigned to functions by the data processing installation, which functions are controllable by selecting these panel regions by means of the input marking. A classic example of such an input panel is the display screen of a data processing installation in conjunction with a computer mouse and a cursor displaceable by means of this mouse on the display screen, using panel regions in the form of buttons which can be clicked, for example. A further classic example are touch-sensitive display screens in which inputs into the data processing installation are possible by pressing by means of a finger on symbols displayed by the data processing installation.

AT 506617 A1 proposes implementing an input panel consisting of display panel—typically a projection screen—and photosensitive detector panel, for a data processing installation, wherein the data processing installation is controllable by the user via the position of the light spot produced by a laser pointer on the display panel, which light spot is to be understood as an input marking. The photosensitive detector panel is constructed as a planar optical waveguide containing a layer having photoluminescent properties, on which photoelectric sensors are applied. Light of suitable wavelength, which is incident on the photoluminescent layer, is absorbed therein and produces light of greater wavelength by photoluminescence, which is conducted in the optical waveguide to the photoelectric sensors and produces an electrical signal therein. The amplitude of the electrical signals on the sensors is dependent on the intensity of the incoming light and therefore on the distance of the causative light spot on the optical waveguide from the individual sensors. Therefore, the position of the causative light spot can be back-calculated from the electrical signals measured at the individual sensors.

AT 507267 A1 describes a photosensitive, position-sensitive input panel for a data processing installation, which, like the panel according to AT 506617 A1, is also based on luminescence wave guiding. For the case in which the input panel is arranged on the visible side in front of a display panel, it is suggested that the luminescent pigment be selected such that it predominantly absorbs at the edge of the visible color spectrum.

This concept for input panels has the advantage that it is implementable cost-effectively above all also in the case of large-area embodiments, and therefore digital signals are also correctly identifiable with very high bit rate per unit of time. Furthermore, this concept allows an input from greater distance, if the light spot is generated by means of a special laser pointer.

Interference and restrictions result from the fact that the display panel and photosensitive detector panel applied thereon unfavorably influence one another. Because light from the waveguide mode is lost by decoupling to the display panel, the triggering light pointer must operate at a very high light intensity. The light decoupled from the waveguide mode to the display panel produces interfering color effects there. The detector panel can additionally interfere with the display, if it lies between the display panel or parts of the display panel and the observer.

The stated object on which the invention is based consists of providing an input panel consisting of a display panel and a photosensitive detector panel, for a data processing installation, wherein the detector panel is based on the functional principle described in AT 506617 A1 and AT 507267 A1. In relation to the construction known for this purpose, the decoupling of light from the waveguide mode of the detector panel to the display panel is to be reduced, without interfering stronger visibility of the detector panel thus occurring.

To achieve the object, it is proposed according to the invention that detector panel and display panel be arranged at a distance to one another in a joint assembly of parts which are not movable relative to one another and an air layer be provided as a layer which adjoins the detector panel on the display panel side.

A stronger change of the index of refraction occurs at the boundary layer of the detector panel because an air layer adjoins the detector panel, whereby the boundary angle of the total reflection is relatively steep and light is hardly still lost from the waveguide mode to the environment.

Elements which are opaque are necessarily attached to the detector panel. The photoelectric sensors, which also must be arranged on regions located remotely from the edges, for reasons of the desired good location resolution of the detection on the detector panel, are certainly opaque. The connection lines thereto are also at least conditionally opaque. With the raising of the detector panel from the display panel, it is no longer quite so simple to position these opaque elements with respect to the detector panel such that they hardly interfere. However, these problems may be managed surprisingly well by a bundle of measures which must be adapted to the type of the display panel used.

The invention will be illustrated on the basis of drawings:

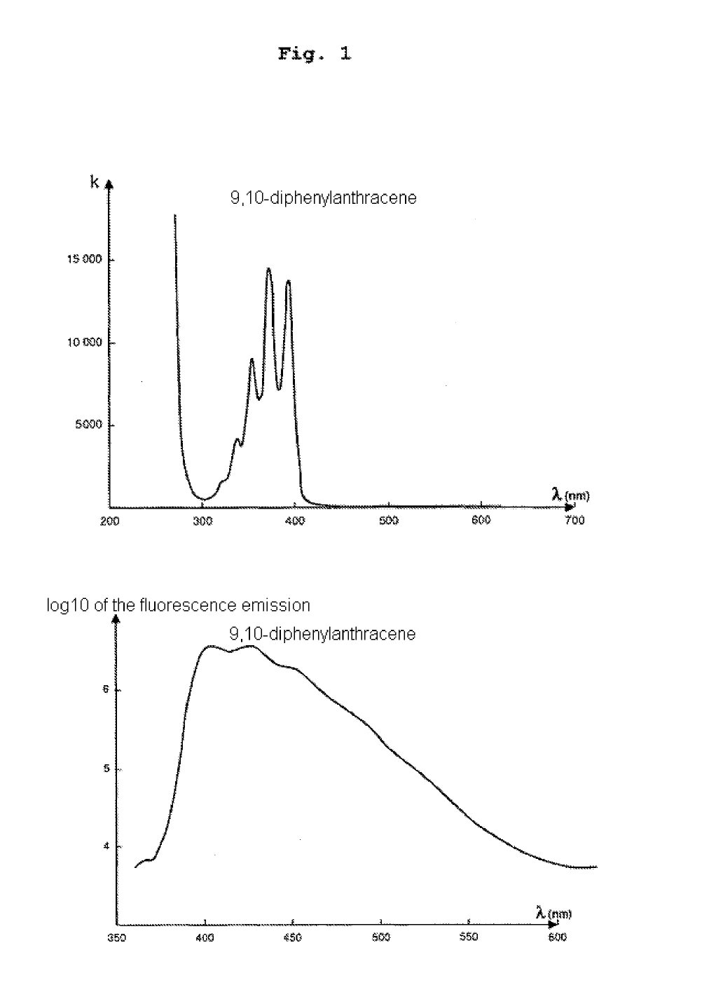

FIG. 1 shows, for the exemplary pigment 9,10-diphenyl-anthracene (DPA), which is usable as a fluorescent pigment in an input panel according to the invention, absorption of incident light and emission of fluorescent light via the light wavelength in two graphs.

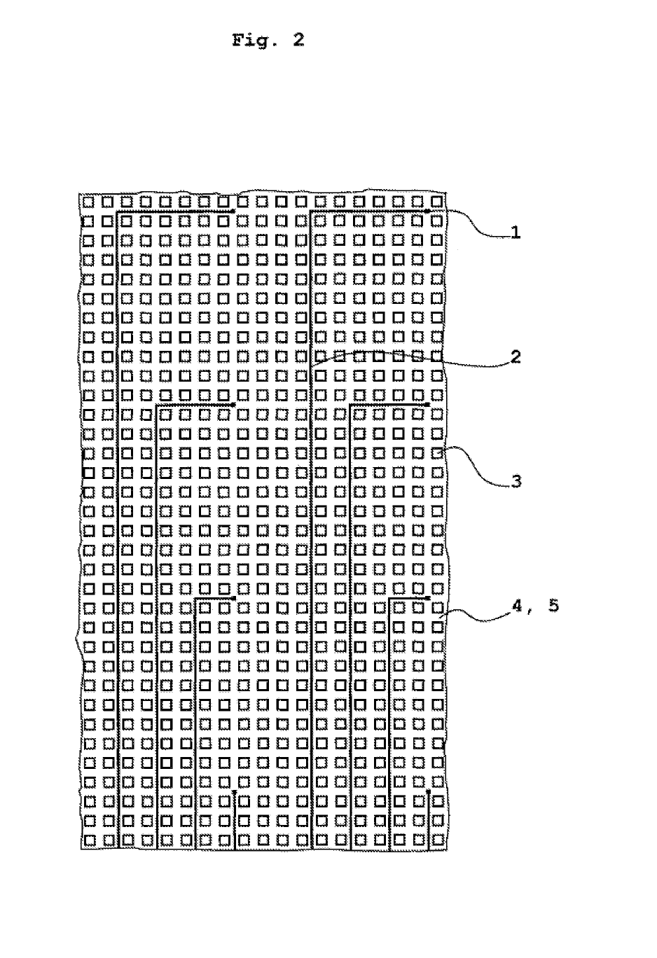

FIG. 2 is a schematic sketch of a first input panel according to the invention in a frontal view.

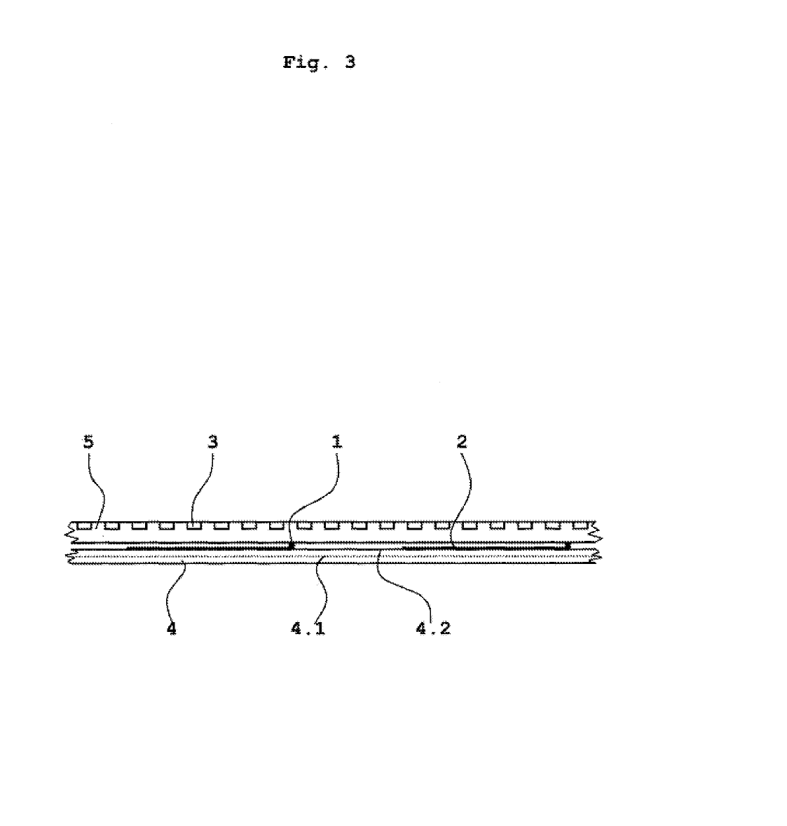

FIG. 3 is a schematic sketch of the input panel of FIG. 2 in a side view.

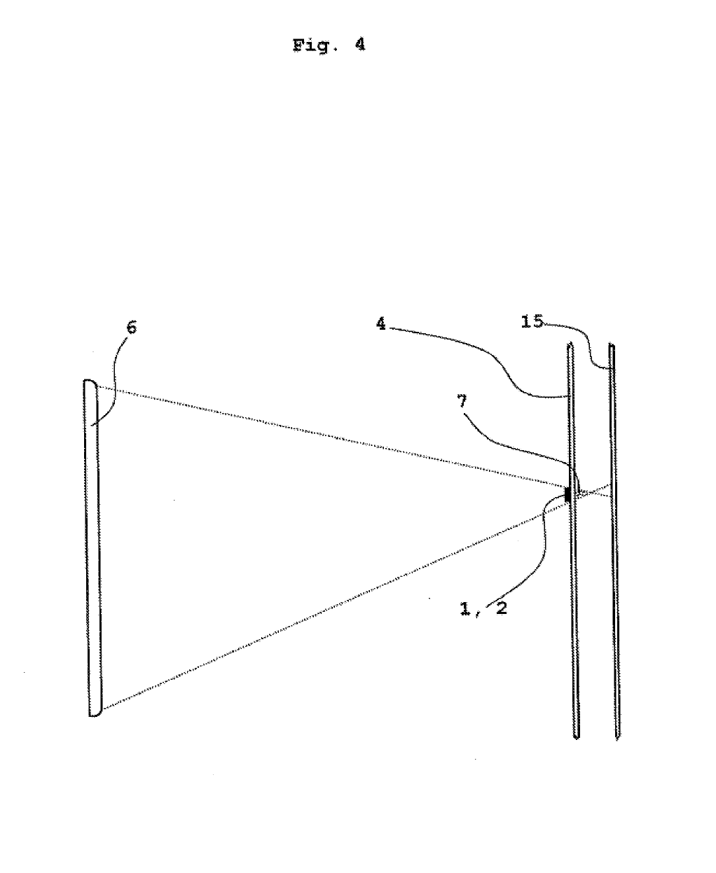

FIG. 4 is a schematic sketch of a second input panel according to the invention in a side view.

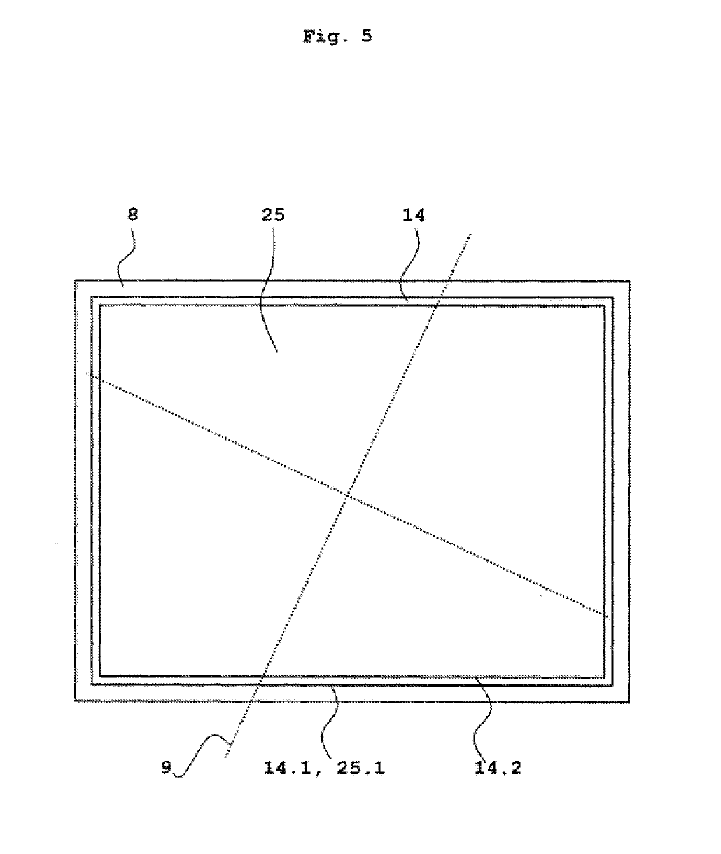

FIG. 5 is a schematic sketch of a second input panel according to the invention in a frontal view.

The layer structure of the photosensitive detector panel 4 is sketched in FIG. 3. In large part, the detector panel consists of a transparent plastic, typically PET or polycarbonate, in the form of one or more layers. A luminescent pigment is introduced in high concentrations into the polymer in at least one of these layers 4.1. The introduction is preferably performed by co-extruding the polymer and the pigment.

For the present application, it is important that the absorption of the pigment lies far on the edge of the visible light spectrum and only covers a small spectral range there. Typically, noteworthy absorption only occurs in a narrow band at wavelengths of less than 425 nm or of greater than 625 nm. The pigment thus produces only a very weak color impression on the (visible) detector panel (ideally no color impression at all) and a light pointer using visible laser light can nonetheless be used.

Light pointers using visible light are much preferable for safety reasons over those using infrared light, although the latter would be advantageous with respect to the color impression on the detector panel. Specifically, because of its invisibility when dazzling an eye, infrared light hardly triggers a protective reflex in the eye, although it causes damage in the eye at high intensity like visible light. Infrared light pointers therefore can only be operated using extremely low light intensities. The same argument as against IR light speaks against UV light. Furthermore, a light spot made of visible light offers the user an orientation as to which direction the light pointer is pointing, especially if it is a laser pointer, which is used from a distance.

For example, 9,10-diphenylanthracene (DPA), which only absorbs in deep blue, or squarylium dye III (SqIII), which only absorbs in deep red, are suitable as pigments. Both pigments only give a weak color impression even in high concentrations, which can be corrected by color adjustment of the display. SqIII absorbs laser light at 640 nm, DPA at 405 nm, both standard wavelengths for diode lasers. Both wavelengths are at the edge of the visible spectrum, therefore, on the one hand they are permitted for class lasers, on the other hand, they color so weakly that films, even with high pigment concentrations, are hardly colored. By slight modifications in the molecular structure, in the case of both pigments, the spectra may also be adapted even more precisely to a laser wavelength.

Absorption behavior and luminescence emission behavior as a function of the light wavelength of the pigment 9,10-diphenyl-anthracene are shown in FIG. 1. It can be seen that this pigment only noticeably absorbs at wavelengths in the deep-blue wavelength range. A film which contains this pigment, even in high concentrations, will accordingly hardly have a color impression and will not noticeably interfere with the readability of a display located behind it.

Depending on the functional principle of the display panel 5, 15, it is advantageous to arrange the detector panel 4, from the viewpoint of the observer, in front of or behind the display panel.

In display panels in which the displayed image is generated by a plurality of controllable light sources arranged on the display panel itself, the detector panel must be arranged on the observer side of the display panel.

Such a combination of display panel 5 and detector panel 4 is shown in FIG. 2 and FIG. 3.

The display panel 4 has light sources 3, typically LEDs or combinations of LEDs or the plasma pixels of a plasma display screen, which are arranged in rows and columns to form a pixel grid on the display panel, wherein the light sources 3 (=pixels) do not lie close to one another, but rather wherein a small distance lies between the light sources. The parts of the detector panel 4 which are necessarily not transparent must be embodied as finely as possible and arranged such that they lie between the light sources 3 with respect to coordinates lying parallel to the display panel.

According to FIG. 2, the necessarily nontransparent photoelectric sensors 1 are accordingly arranged between light sources 3 and respectively one—for reasons of expenditure typically also embodied as nontransparent—electrical conductor path 2 extends to a photoelectric sensor 1 in the intermediate space between two rows or two columns of light sources (3).

Especially in the case of large display panels embodied as LED walls, in which the input by means of light pointers is outstandingly important, the width of the empty space between adjacent light sources is several millimeters to centimeters, so that sensors (1) and conductor paths (2) readily find space between the light sources.

The required second terminal (ground terminal) on the photoelectric sensors 1 is preferably implemented as a thin, transparent, substantially uninterrupted conductive surface layer 4.2.

The photoelectric sensors 1 are typically photodiodes embodied as a silicon chip. They can be bonded directly onto small conductor surfaces, whereby the covered surface is minimized. In a construction which is currently readily available, they are square and cover an area of 0.3 mm². The photoelectric sensors 1 can also be embodied as a chip, which, in addition to the photoelectric conversion, also assumes the function of the trans-impedance amplifier (current-voltage conversion and amplification).

The conductor paths 2, i.e., the electrical connection between the photoelectric sensors 1 and the readout electronics, are typically embodied for reasons of expenditure as a narrow, nontransparent metal layer. They must be embodied as very thin and precisely positioned, so that they can find space between the light sources 3 and are not noticeable. For rapid applications, it is advisable to shield these conductor paths 2. This can be performed by means of transparent, conductively coated films, for example, conductive polymers.

With progressing technological development, it will certainly become simpler and more cost-effective to also embody the conductor paths 2 as transparent, for example, from conductive polymers, nanotubes, or graphene.

In order that the photoelectric sensors 1 and the nontransparent conductor paths 2 of the detector panel 4 never cover light sources 3 upon observation of the display panel 5 from the largest possible viewing angle range, the detector panel 4 must be arranged very close to the display panel.

In a very advantageous embodiment, the photoelectric sensors 1 protrude beyond the surface layer 4.2 of the detector panel 4 and the outer surface of each photoelectric sensor 1 is in physical contact with the display panel 5.

By arranging the photoelectric sensors 1 distributed at a uniform distance grid to one another over the entire detector panel 4, a more uniform, very small distance is therefore stably set between the part of the detector panel 4 functioning as a waveguide and the display panel 5. If the display panel 5 is not planar but rather somewhat convexly curved toward the user side, it is important that the height of the photoelectric sensors 1 protruding beyond the detector panel 4 is greater than the outward curvature of the display panel between points of the display panel at which photoelectric sensors 1 are arranged. It is advantageous to provide a cover layer on the photoelectric sensors 1 on the side facing away from the detector panel 1, by which cover layer the height of the sensors 1, which is effective for the spacer function, is increased and which also protects the sensors.

In a preferred embodiment, the electric lines to the photoelectric sensors 1 protrude beyond the surface layer 4.2 of the detector panel 4, said lines consist of a conductor path 2 and an insulating material layer. The lateral surface part of said lines that is facing away from the detector panel is in physical contact with the display panel 5. A particularly stable alignment of the distance between detector panel 4 and display panel 5 thus results.

FIG. 4 illustrates the relationships if a display panel 15 is used, which is at least partially transparent and is irradiated by a light source 6 from the side facing away from the user. This is the case in LCD display screens and rear projection screens. The detector panel 4 is preferably arranged in the space between the light source 6 and the display panel 15, i.e., on the side of the display panel 5 facing away from the user. In contrast to the above-described arrangement, a greater distance between display panel 15 and detector panel 4 is advantageous here. This distance is to be greater than the length, which protrudes away from the detector panel 4, of the deepest shadow 7 of nontransparent parts of the detector panel 4, typically of photoelectronic sensors 1. Therefore, no deepest shadows 7 of nontransparent parts fall on the display panel 15. These nontransparent parts therefore produce only a very low contrast image, which often cannot even be perceived with the eye, on the display panel 15. In order that a light spot detected on the detector panel 4 correlates well with the point of intersection of the light beam of the light pointer with the display panel 15 during irradiation from the widest possible angle range, the detector panel 4 is not to be located unnecessarily remotely from the display panel 15. The smaller-area and finer opaque parts (photoelectric sensors 1, conductor paths 2) of the detector panel 4 are, the closer can the detector panel 4 be moved toward the display panel 15, since the deepest shadows 7 of the nontransparent parts are shorter. In the case of a large-area light source, for example, in an LCD display screen, the distance between detector panel 4 and display panel 15 can be very small in any case, since due to the distributed emission surface (i.e., due to the large area of the light source 6), the deepest shadows are only present in an extremely small region in front of the very small-area photoelectric sensors 1.

In both discussed construction principles, it is advisable to arrange the readout electronics for the photoelectric sensors 1 of the detector panel 4 at the edge of the detector panel, outside the part of the display panel 5, 15 used for the image reproduction. The readout electronics are typically a chip, in which the electrical signals of a plurality of photoelectric sensors 1 are processed and the measurement information is transferred to a data line leading away.

The use of a light beam which has two spectral ranges, of which one range relates to visible light and the second range to IR light or UV light, is also entirely conceivable and advantageous in an important aspect. Typically, two light sources can be combined in one light display device for this purpose, specifically one source which emits in the visible spectral range and one source which emits nonvisible light, i.e., IR light or UV light, in a spectral range only effective for the detector panel. This has the advantage that a detector film can then be used, which exclusively absorbs in the nonvisible spectral range and nonetheless a visible marking can be seen on the display panel. In addition to the expenditure for two light sources, this has as a disadvantage the danger or the unpleasant feeling that the visible light component can fail for some reason and the nonvisible light component could nonetheless be present. This would mean that no protective reflex would be triggered if the remaining nonvisible light component—which must have relatively high intensity in normal operation to be practically usable—is incident in an eye and causes damage by dazzling therein.

This hazard can be avoided by linking the controllers of the two light sources—predominantly electronically—such that if the source of visible light fails, the source of IR light or UV light is reliably also turned off or shaded. At least in a psychological aspect, however, a disturbing residual uncertainty can remain in the case of persons who know about this functional principle.

Instead of the combination of two light sources, one of which illuminates with relevant intensity in the visible spectral range and the second illuminates with relevant intensity in the IR range or UV range, of course, a single light source can also be used, which illuminates with relevant intensity in both spectral ranges.

If one light beam is applied, which has two spectral ranges as just mentioned, it is also advantageous to provide an air cushion between display panel 5, 15 and detector panel 4, to avoid radiation loss by excessively strong decoupling from the waveguide mode into the detector panel 4. However, it is no longer so extremely important, since at least the effect of undesired color appearances on the display panel can be avoided if the light conducted in the waveguide mode of the detector panel 4 also lies in the IR spectrum or UV spectrum.

According to FIG. 4, detector panel 14 and display panel 25 are mounted on a joint frame 8, which encloses both panels 4, 5. While the display panel 25 is rectangular over the entire area as usual, the detector panel 14 is only implemented as a narrow strip, which covers a peripheral edge strip of the display panel 25. The edge 25.1 of the display panel 25 is thus congruent—upon observation with normal viewing direction to the panels 14, 25—with the outer edge 14.1 of the detector panel. The detector panel 14 forming a rectangular frame is delimited toward the center of the display panel 25 by an inner edge 14.2, within which the display panel 25 is not covered by the detector panel 14.

In order to nonetheless be able to mark a position in the middle region of the display panel 25 using a light pointer, the cross-sectional area of the light beam emitted by the light pointer is implemented as cross-shaped, so that the light spot 9, which this light beam produces on the panels 14, 25, is also cross-shaped. Because the cross-sectional dimensions of the light beam in the distance range in which the panels 14, 25 are located from the pointer device are set to be sufficiently large that a plurality of lines of the light spot 9 are incident in any case on the detector panel 14, which is only located over the edge of the display panel 25, the position of the center of the light spot can be back-calculated from the detection results thus produced. Shading which is caused by the detector panel 14 or nontransparent parts thereof hardly interfere, because it only affects the outermost edge of the display panel 25. If the width of the strip of the detector panel 14 is significantly greater than the width of the individual lines of the light spot 9 and if a plurality of rows of photoelectric sensors are arranged at a distance to one another and next to one another along the strip of the detector panel 14, the alignment of a line of the light spot is recognizable from the detection result of a group of photoelectric sensors adjacent to one another, which line intersects the detector panel 14 in the near field of these photoelectric sensors. Calculating the position of the center point of the light spot 9 is thus simplified and the cross-sectional dimensions of the light beam can be kept somewhat smaller.

In an advantageous embodiment, the light pointer is embodied such that it emits light in a visible spectral range and in a nonvisible spectral range, wherein the cross-section center of the joint light beam is emphasized in the visible spectral range. The construction according to FIG. 5, according to which the detector panel 14 only extends on the edge of the display panel 25, is applicable both if the detector panel lies in front of the display panel from the viewpoint of the observer, and also if it lies behind the display panel from the viewpoint of the observer.

1.-14. (canceled)

15. An input panel comprising:
a display panel; and
a photosensitive detector panel for controlling a data processing installation via the position of the point of incidence of a light beam, said photosensitive detector panel generates electrical output signals, which are dependent on the point of incidence of the light beam, said detector panel is constructed as a transparent planar optical waveguide, which has a layer, in which a pigment having photoluminescent properties is contained and photoelectric sensors are attached to said optical waveguide, said photoelectric sensors generate an electrical signal by decoupling the light that is guided in the optical waveguide, said photosensitive detector panel is aligned parallel to said display panel,
wherein said detector panel and said display panel are arranged at a distance to one another, and the layer which adjoins the detector panel on the display panel side is an air layer.

16. The input panel as claimed in claim 15, wherein photoelectric sensors are arranged at points located remotely from the edges of the detector panel.

17. The input panel as claimed in claim 16, wherein the photoelectric sensors are attached to the surface of the detector panel in a regular pattern.

18. The input panel as claimed in claim 15, wherein a pigment having photoluminescent properties predominantly only absorbs visible light from a narrow edge region of the spectral range of visible light.

19. The input panel as claimed in claim 15, wherein the display panel has a multiplicity of light sources, the detector panel is arranged on the user side of the display panel and the photoelectric sensors protrude from the detector panel and the outer surface of the photoelectric sensors is in contact with the display panel.

20. The input panel as claimed in claim 15, wherein the display panel has a multiplicity of light sources, the detector panel is arranged on the user side of the display panel, electrical lines run over the detector panel, which respectively contain a conductor path connected to a photoelectric sensor, the cross-sectional area of said electrical lines protrudes from the detector panel and the lateral surface part of said electrical lines facing away from the detector panel are in contact with the display panel.

21. The input panel as claimed in claim 15, wherein the display panel has a multiplicity of light sources said light source are LEDs.

22. The input panel as claimed in claim 15, wherein the display panel has a multiplicity of light sources said light source are plasma pixels.

23. The input panel as claimed in claim 15, wherein the display panel has a multiplicity of light sources said light sources are arranged in a grid of rows and columns spaced apart from one another, and the photoelectric sensors and the conductor paths leading thereto are arranged between or run between these rows and columns in the normal projection on the display panel.

24. The input panel as claimed in claim 15, wherein the display panel is at least partially transparent and is illuminated by a light source from the side facing away from the observer, the detector panel is arranged between light source and display panel, and the distance between the detector panel and the display panel is greater than the length of the deepest shadow, which is cast by opaque elements of the detector panel in the light of the light source.

25. The input panel as claimed in claim 23, wherein the display panel is an LCD display screen.

26. The input panel as claimed in claim 23, wherein the display panel is a rear projection screen.

27. The input panel as claimed in claim 15, wherein the detector panel only extends over an edge strip of the display panel and not over the panel center thereof.

28. An input panel comprising:
a display panel;
a photosensitive detector panel for controlling a data processing installation via the position of the point of incidence of a light beam, said photosensitive detector panel generates electrical output signals, which are dependent on the point of incidence of the light beam, said detector panel is constructed as a transparent planar optical waveguide, which has a layer, in which a pigment having photoluminescent properties is contained and photoelectric sensors are attached in a regular pattern over the whole surface of the optical waveguide, said photoelectric sensors generate an electrical signal by decoupling the light that is guided in the optical waveguide, said photosensitive detector panel is aligned parallel to said display panel; and
a light pointing device that emits a light beam onto the input panel and display panel jointly, which has radiation components in two different spectral ranges, wherein one radiation component lies in the spectral range of visible light and the second radiation component lies in the spectral range of IR light or UV light, and wherein only the radiation component provided as IR light or UV light is absorbed by the detector panel.
